(19) United States
(12) Patent Application Publication
(10) Pub. No.: US 2026/0157407 A1
(43) Pub. Date: Jun. 11, 2026

(54) COMPOSITIONS AND METHODS FOR PRODUCING SORGHUM NUTRACEUTICALS

(71) Applicant: Flatland Genomics LLC, Abernathy, TX (US)

(72) Inventors: Edward Souza, Manhattan, KS (US); Jack Parker, Franklin, NJ (US)

(21) Appl. No.: 19/416,522

(22) Filed: Dec. 11, 2025

Related U.S. Application Data
(60) Provisional application No. 63/730,918, filed on Dec. 11, 2024.

(51) Int. Cl. A23L 7/10; A23L 5/00; A23L 5/20

(52) U.S. Cl. CPC A23L 7/197; A23L 5/23; A23L 5/51

(57) ABSTRACT

An apparatus, composition, and method are provided for processing red and black sorghum seed. The process includes mechanically separating the seed into bran and endosperm-rich material, combining the bran with ethanol, filtering the resulting mixture through a resin-based filtration system, and evaporating the ethanol to produce an extraction product. Also disclosed are an apparatus and method for producing a sorghum isolate composition comprising a 3-DA concentrate in which the 3-DA concentration is at least twice that of whole seed, and the lead concentration is below 200 ppb. In certain embodiments, the mercury concentration is below 100 ppb, the cadmium concentration is below 100 ppb, or the arsenic concentration is below 200 ppb. Additional embodiments achieve 3-DA concentrations at least 100 times higher than whole seed, at least 1,000 times higher than whole seed, at least 2,000 milligrams per kilogram, or any combination of these levels.

### CROSS-REFERENCE TO RELATED APPLICATIONS

This application claims priority to U.S. Provisional Application Ser. No. 63/730,918 filed Dec. 11, 2024, titled, “Compositions and Methods of Producing Sorghum GLP-1 Nutraceuticals,” which is incorporated herein by reference in its entirety.

### FIELD

Embodiments of the invention generally relate to compositions and methods of producing sorghum compositions to encourage antioxidant production or help regulate hormones in humans.

### BACKGROUND

Consumption of sorghum as part of the human diet may contribute to reductions in obesity, cancer, and inflammatory diseases when compared to maize-based diets and, more broadly, to diets low in fiber and high in fat. These health benefits are primarily associated with the antioxidant activity of 3-deoxyanthocyanidins (3-DA), the predominant pigments in red- and black-seeded sorghum varieties. The presence of 3-DA has been linked to decreased inflammation, inhibition of adipocyte formation, and the generation of resistant proteins and starches that promote fiber development, ultimately supporting improved glycemic control through enhanced colon microbiome activity.

Processing various sorghum plant components for food or other uses is nearly as old as sorghum cultivation itself. However, traditional methods, such as heating seeds to produce porridge or performing alkaline extractions of leaf sheaths to make traditional African red dyes, yield unacceptable and unpalatable products to many consumers. Although a daily intake of 50 grams of sorghum has been shown to lower blood glucose levels and reduce obesity, adherence to such a diet can be difficult for many individuals.

In view of the foregoing, it is apparent that a need exists in the art for compositions and methods for producing sorghum-based food products for human consumption that are palatable, promote human health, and address or overcome the limitations associated with the above problems in the art. It is a purpose of this invention to fulfill this and other needs in the art which will become more apparent to the skilled artisan once given the following disclosure.

### SUMMARY OF THE INVENTION

It is an object of the present invention to overcome the above-described drawbacks associated with current compositions and methods for producing sorghum nutraceuticals. To achieve these and other advantages and in accordance with the purpose of the invention, as embodied and broadly described, the present disclosure describes compositions and methods for producing sorghum nutraceuticals.

Embodiments disclosed herein relate to apparatus, compositions, and methods for processing red and black sorghum seed. The process may include mechanically separating seed components into bran and endosperm-rich material, combining the bran with ethanol, filtering the bran and ethanol with a filter comprising resin, and evaporating the ethanol to obtain an extraction product. In certain embodiments, the extraction product is combined with other materials to produce a palatable food item, or a centrifuge is used to remove solids, a fat-containing phase, or both. In some embodiments, ethanol evaporation is performed using a heat source, the filtration step is repeated, and/or the filter comprises resin beads.

Embodiments disclosed herein also relate to apparatus, compositions, and methods for producing a sorghum isolate composition including a 3-DA concentrate, wherein the concentration of 3-DA is at least twice the concentration of 3-DA in whole sorghum seed, and wherein the concentration of lead is less than 200 ppb. In some embodiments, the concentration of mercury is less than 100 ppb, the concentration of cadmium is less than 100 ppb, and/or the concentration of arsenic is less than 200 ppb. Additional embodiments provide a 3-DA concentration at least 100 times that of whole sorghum seed, a 3-DA concentration at least 1000 times that of whole seed, a 3-DA concentration at least 2000 milligrams/kilogram, a 3-DA concentration at least 4000 milligrams/kilogram, or a combination thereof. In some embodiments, the 3-DA concentrate is provided as a dry powder.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention.

In the drawings:

FIG. 1 is a schematic of a workflow in accordance with the teachings of the present disclosure.

FIGS. 2A, 2B, and 2C are a series of figures illustrating seeds with an agitator, crushed seeds in a mesh bag seeping in a vessel with ethanol undergoing agitation, and a viscous post-extraction solution.

FIGS. 3A, 3B, and 3C are a series of figures showing the separation of a fat layer from a solution using a separatory funnel, a close-up perspective view of a separatory funnel, and a close-up perspective view of the effluent from the base of the funnel.

FIG. 4 is a perspective view of a column containing beads of resin and fluid flowing through the column collected in a vessel at the base of the column.

FIGS. 5A, 5B, and 5C are perspective views of embodiments of resin extraction columns and a collected solution.

FIG. 6 is a perspective view of a column undergoing a rinse after the fluid had undergone resin extraction.

FIG. 7 is a perspective view of a sample collected after a solvent was distilled.

FIGS. 8A and 8B are perspective views of a sample undergoing freeze-drying and the sample at the conclusion of freeze-drying.

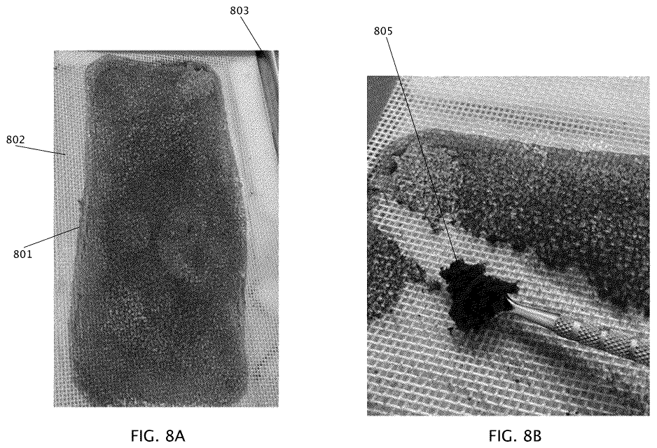

### DETAILED DESCRIPTION

Exemplary embodiments of compositions and methods for producing sorghum nutraceuticals in accordance with the present disclosure are discussed herein. Many other uses of the present invention will become obvious to one skilled in the art upon acquiring a thorough understanding of the present invention. Once given the below disclosures, many other features, modifications and variations will become apparent to the skilled artisan in view of the teachings set forth herein. Such other features, modifications and variations are, therefore, considered to be a part of this invention.

Embodiments herein include compositions and methods of using whole grain from a cereal species (e.g., Sorghum bicolor, Zea mays, Hordeum vulgare, Triticum aestivum, Triticum dicoccoides var. durum, Triticosecale X, Avena sativa, and the related wild species of these cultivated species) that contain 3-deoxyanthocyanidins (3-DA) in the aleurone, pericarp, embryo, or endosperm of the seed. 3-DA has been expressed in the endosperm of corn using genetic modification. Similar technology may be used to modify sorghum.

Utilizing red and black sorghum as raw materials for producing sorghum-based nutraceuticals can enhance consumer antioxidant intake and support the management of inflammation and obesity. Sorghum contains a variety of components that include flavanols. In red- and black-seeded sorghum, 3-deoxyanthocyanidin (3-DA) flavonoids—such as luteolinidin, apigeninidin, and the derivatives 5-methoxyluteolinidin and 7-methoxyapigeninidin—accumulate within the seeds of Sorghum bicolor. Sorghum varieties suitable for certain embodiments include, but are not limited to, 02CA4796, B.01336, 99GW092, 98BRON155, 99LGW050, B.9904, Tx2911, SC719-11E, 98CA4779, SC103×SC748 (light), SC103×SC748 (dark), Tx430 Black, Black Pl Tall, or combinations thereof.

Initial preparations use whole grain from a cereal species (Sorghum bicolor, Zea mays, Hordeum vulgare, Triticum aestivum, Triticum dicoccoides var. durum, Triticosecale X, Avena sativa, and the related wild species of these cultivated species) that contain 3-deoxyanthocyanidins in the aleurone, pericarp, embryo, or endosperm of the seed. The presence of 3-DA compounds in the seed may arise from naturally occurring genetic variation, intentional selection for elevated 3-DA concentrations, or from cis- or transgenic methods (e.g., genetic modification or gene editing using gene sequences originating from the listed species above, transferred from another species, or modified using sequences generated by human design). For brevity, subsequent methods will focus on the use of sorghum (i.e., Sorghum bicolor), though the methods are equally applicable to the grains of the other referenced species.

The seeds are reduced to a fine particle size through one or a combination of the following methods: abrasion, pearling, flaking, hammer milling, or roller milling with smooth or corrugated rolls. The definitions of these methods follow the technical terms of the American Association of Cereal Chemists (AACC). Whole-grain particles may be used in some embodiments, but efficiency is improved by sifting the bran materials away from the endosperm tissues. Mechanically, this reduction in particle size is achieved by a pearling process (also called decortication), hammer milling, or roller milling. Efficiency is further improved when a purification step is added to isolate the particles with the highest concentrations of 3-DA. In sorghum genotypes selected for the highest concentrations of 3-DA, the aleurone and pericarp tissues serve as the primary storage tissues for 3-DA, while 3-DA is absent in the starchy endosperm. Failure to remove the starchy endosperm from the extracted materials reduces purification efficiency because fragmented short-chain starch molecules are difficult to separate from the 3-DA via centrifugation and filtration, and the starchy endosperm impedes flow rates during resin-based purification.

The tissues with high concentrations of 3-DA can be isolated by aspiration following abrasion and pearling, or by sifting after abrasion, pearling, hammer milling and/or roller milling. Ground particles may be sifted away from the endosperm using fine-mesh screens to concentrate the bran into the final fraction for extraction. These materials, composed primarily of aleurone, pericarp, and embryo tissues, are also referred to as bran. For clarity, seed material subjected to extraction will be referred to as bran in subsequent processing steps. In certain embodiments, this material may consist of whole grain seeds, partial fractions of seed, pericarp alone, or a combination of pericarp and aleurone.

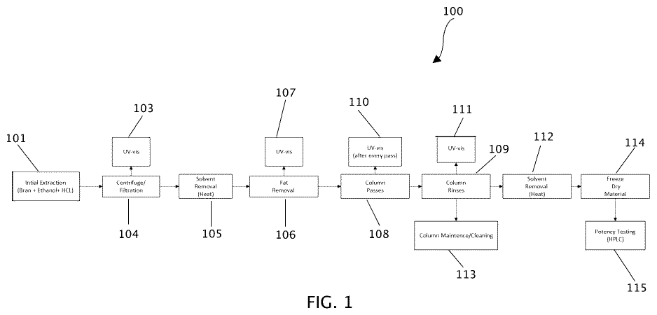

FIG. 1 presents a flowchart for a process 100 designed to concentrate components of sorghum seeds. The initial extraction step 101 includes suspending the bran in an acidified polar solvent, such as hydrochloric acid in ethanol. Additional sample preparation steps, including mechanical shearing or enzymatic treatments with cellulase, protease, or amylase, may further enhance 3-DA extraction efficiency. Suitable polar solvents include acetone, methanol, ethanol, water, dimethyl sulfoxide (DMSO), and other polar solvents used in food and nutraceutical applications. In some embodiments, ethanol is selected as the extraction solvent. The bran is suspended in an excess of acidified solvent.

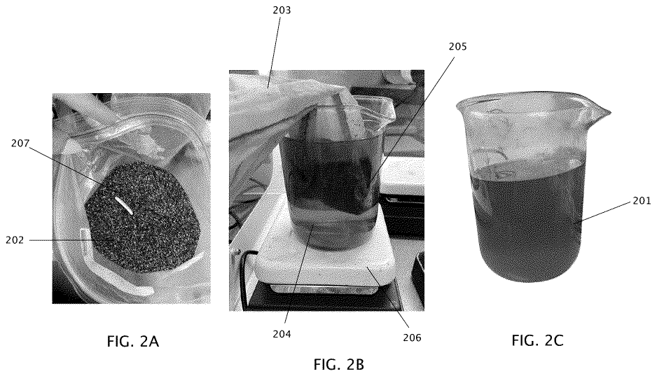

FIGS. 2A, 2B, and 2C illustrate this initial extraction using a sorghum sample containing high concentrations of 3-DA. As shown in FIG. 2A, a reduced-particle-size sorghum bran sample 202 is placed in a mesh bag 203, which is then submerged in a beaker containing solvent 204, as shown in FIG. 2B. In some embodiments, the bran can be placed in a mesh container for ease of removal from the polar solvent. In other embodiments, the bran is placed in a mesh bag, and then the bran particles are submerged or suspended in a vessel, such as a beaker containing ethanol, which ethanol may be diluted with water at concentrations ranging from 5 weight percent to 50 weight percent. The extraction solution is acidified to a pH between 1.0 to 6.0 using concentrated hydrochloric acid, with some embodiments using extraction solutions with a pH below 2.0.

The bran fraction containing the 3-DA concentration 205 is heated and stirred while suspended in the solvent. The combined contents of the vessel, the bran and solvent, are then agitated and heated to temperatures ranging from 30° C. to 43° C., or in some embodiments 37° C. to 43° C., for a duration of approximately two hours. A hot plate 206 or other heat source may be used to heat the contents of the vessel. In some embodiments, the heat is set to 110° C. Higher temperatures increase evaporative loss of the solvent, whereas lower temperatures slow the rate of extraction. For solvents, such as acetone and methanol, lower temperatures are required to minimize volatilization of the solvents. Agitation of the suspension can be used to accelerate the extraction process. Continuous flow systems can be used to pass solvent through sample materials, thereby improving extraction efficiency. Some embodiments use an agitator, such as a stir bar 207, set at a speed of approximately 200 rpm. In larger-scale operations, a batch method may be used for extraction, wherein the batch method may be similar to this operation or use a continuous flow of solvent through a sample retained by a mesh, cloth, or screen.

The result is a crude extraction 201 from the sample as shown in FIG. 2C. In some embodiments, the extraction mixture may consist of 5 weight percent bran, 92 weight percent ethanol, and 3 weight percent acidified water containing 1 weight percent hydrochloric acid (HCL). Other embodiments may use lower ratios of solvent (e.g., 50 weight percent bran and 50 weight percent solvent) or greater ratios of solvent (e.g., 1 weight percent bran and 99 weight percent solvent), or variable solvent volumes (e.g., in continuous-flow systems where solvent is passed through the bran in a wash or filtration-based system).

Bran may be separated 104 from the solvent using several different approaches. Some embodiments utilize a two-step process for separation 104. Large particles may be separated by filtration 104 with mesh, filters, or fine screening materials. The filtration process can be accelerated by applying a vacuum. In some embodiments, the supernatant, after removing large particles, is further purified by removing fine particles through centrifugation 104 or by employing additional filtration using a porous membrane. In other embodiments of the bran separation process, single-step bran separation or removal from the solvent may be achieved via a three-phase centrifuge.

Some embodiments utilize ultraviolet-visible (UV-vis) spectroscopy 103 to verify the fluid exhibits the expected properties indicating that the target 3-DA compounds have been extracted. UV-vis is used to measure the extent to which a sample absorbs ultraviolet or visible light. This technique provides information regarding the concentration and properties of substances present in a solution. By analyzing the specific wavelengths at which a sample absorbs light, one can infer details about its molecular structure and overall composition.

To remove microbial activity and increase the shelf-life stability of the 3-DA sample, a pasteurization process may be used. After separation and removal of the bran, the 3-DA compounds are concentrated by evaporation 105 of the polar solvent. When using solvents such as water or water-ethanol mixtures, the solvent is heated to boiling—100° C. in some embodiments-until all the alcohol is removed from the sample or until the water is reduced to a fraction of its initial volume. The alcohol may be recovered using a still. In embodiments using solvents such as acetone and methanol, lower temperatures can be used to remove 105 these solvents.

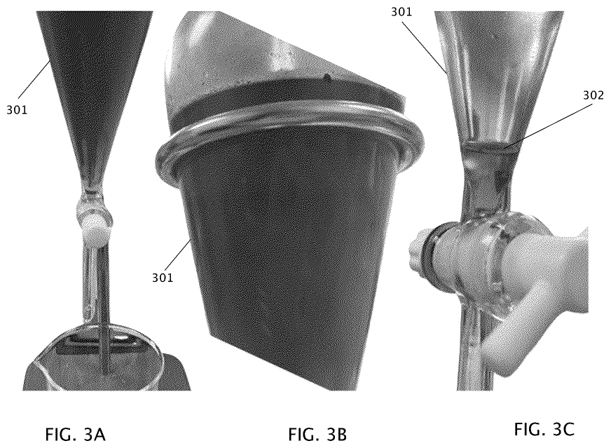

Cooled solutions are centrifuged following the removal of coarse bran particles, long-chain starch and fiber. Removing fat 106 is essential to prevent rancidity, which significantly decreases the shelf life of non-refrigerated products. The liquid from the vessel contents undergoes fat separation 106. FIGS. 3A, 3B, and 3C illustrate how fat removal is managed via the use of a separatory funnel 301. In one embodiment, a Buchner funnel and filter paper may be used once, twice, or many times to separate any lingering suspended solids.

FIG. 3C shows the residual fat 302 following elution of an aqueous layer containing 3-DA. In some embodiments, this residual fat 302 may be removed by three-phase centrifugation or a similar continuous-flow process. Fine bran particles are separated and removed at the lowest level of the three-phase decanter centrifuge, the aqueous phase is removed in the middle, and fats are at the top level closest to the centrifuge's central axis. In other embodiments, industrial equipment such as three-phase disc stack separators and dissolved air floatation systems may be utilized for the removal of fats 106. In three-phase centrifugation systems, solvent volume reduction via evaporation 105 may occur either before or after centrifugation 104 depending on the solvent volume required to achieve optimal flow through the equipment. In one embodiment, a centrifuge may be used at a setting of 3000 rpm for 20 minutes. Additional filtration may be used in other embodiments.

Removing the solvent 105 to concentrate the isolate is accomplished through the application of heat. When using 95 percent ethanol, some embodiments may have a concentration goal of 66.67 percent filtered extraction and 33.33 percent deionized water. In one embodiment, the vessel, such as a beaker, may be placed on a hot plate set to 135° C. with a stir bar. Evaporation 105 continues to remove the ethanol. For embodiments relying on a liter-sized beaker on a hot plate 206 with a starting fluid volume of 700 to 800 mL, this may take six to ten hours. After evaporation 105, the remaining fluid can be cooled to room temperature.

In some embodiments, the remaining fluid contains two phases, a fat layer and a water-based layer. Removing the fat layer 106 may be similar to separation 104 above and may include using a separatory funnel and a mesh bag. The effectiveness of the solvent removal 105 and fat removal 106 can be observed using UV-vis 107. Removal of lipids 106 reduces the risk of rancidity and prevents declines in palatability that can result from lipid oxidation.

Many cereal seeds contain tannins and other condensed aromatic compounds that impart undesirable flavors that reduce the palatability of foods and/or supplements when they are present. Additionally, heavy metals or other harmful byproducts lessen the health benefits of foods made with concentrated cereal forms. For example, controlling arsenic in rice products and concentrates remains a challenge for the food industry. To further improve the safety and palatability of the disclosed extract, some embodiments include a resin purification step 108.

Macro-porous resins may be selected. The purification of the 3-DA compounds may use a range of macro-porous resins based on styrene-divinylbenzene (ST-DVB) copolymer or similar polymers designed for purifying plant compounds. This may include other styrene polymers, such as ST-DVB, with additional chemical modifications to enhance affinity for 3-DA compounds. The resins may be composed of spherical particles having the general characteristics of a uniformity coefficient below 1.6, densities between 1.00 and 1.10 g/ml, bulk densities of 0.65 to 075 g/ml, and particle sizes of 0.20 to 0.80 mm.

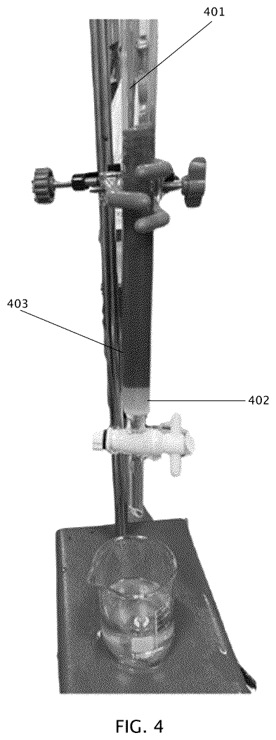

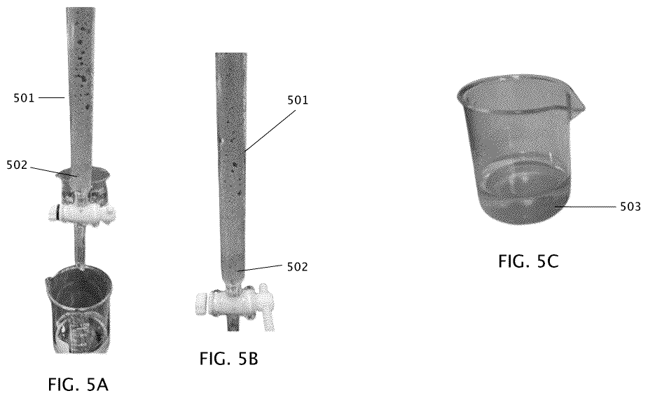

Resins 402 are packed into purification columns 403 and prepared with deionized water 401 as shown in FIG. 4. Concentrated solutions are passed through the column 403 using additional deionized water as a carrier (labeled as step 108 in FIG. 1). Column length and 3-DA retention are optimized by minimizing coloration in the effluent. Measurements are made by spectrophotometry in the UV-visible wavelength range (with peak detection at 485 nm) (labeled as step 110 in FIG. 1). Different resins vary in their retention capacity and flow speed. For example, some embodiments may benefit from resins under the brand name SUNRESIN™ for the purification of 3-DA. Other resins that meet the above specifications may also be used effectively when optimized for resin volume and flow rates. FIGS. 5A, 5B, and 5C show a column 501 configuration with resins 502 with a process to mimic a continuous flow operation. Increasing amounts of 3-DA bind to the resins with each successive pass of the extraction solvent. The measurement of 3-DA within the solvent 503 is calibrated by spectrophotometry at a wavelength of 485 nm (labeled as step 111 in FIG. 1). Lower numbers indicate less 3-DA remains in the solvent.

The 3-DA compounds are eluted from the resin with a 95 weight percent ethanol rinse (labeled as step 109 in FIG. 1). The amount of ethanol used for eluting the compound varies with the resin. Quantities and flow rates may be selected based on spectrophotometry of the eluent to optimize the solute volume and remove the maximum amount of 3-DA with the minimum solvent volume. Solvent volume is reduced through evaporation (labeled as step 112 in FIG. 1). This second evaporation step 112 serves as a secondary pasteurization step to eliminate any opportunistic microbial activity introduced during the purification process shown in FIGS. 5A, 5B, and 5C. The 3-DA is desorbed from the resin using a polar solvent. In some embodiments, 65 weight percent ethanol is used for repeated washes. Each successive wash recovers less 3-DA from the resin. The balance of desorbed 3-DA and solvent quantity is calibrated via spectrophotometry. In some embodiments, successive washes are replaced by continuous flow operations.

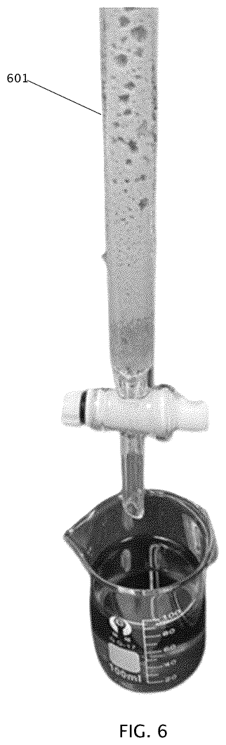

In some embodiments, resin exposure may be selected to remove additional impurities from an isolate. The isolate is passed through a column packed with resin, sometimes repeatedly. The resin column may include a column that acts as a housing, resin either in free form or bound to polymer beads, a quartz frit, and purified quartz sand. For example, SUNRESIN SEPLITE® LXA8101 Adsorbent Resin may be selected for some embodiments. After each resin pass 108, UV-vis 110 may be performed to confirm the isolate's purity. Visual inspection may be performed repeatedly as the solution passes through the column, continuing until the effluent appears clear. Some embodiments may use 30 mL of fluid for each pass through the column. Some embodiments may yield UV-Vis absorption measurements such as an initial reading of 3.820 at 545-380 nm, a post-pass reading of 0.044 at 488 nm, and a post-rinse reading of 1.947 at 498 nm. FIG. 6 shows such a column 601 undergoing washing.

After the column passes 109 are complete, the column may be flushed or rinsed with a 65 percent ethanol solution. The exit solution from the column may be observed with UV-vis 111. Some embodiments may benefit from column maintenance and cleaning 113.

Solvent removal 112 may be carried out using a hot plate set to 135° C. with a stirring rod speed set to 200 rpm. The duration of this step is selected to ensure complete evaporation of the ethanol. Some embodiments may continue to heat the isolate to concentrate its contents by further evaporating water, resulting in a specific concentration of substances. The extraction process efficiently pasteurizes the samples while simultaneously eliminating bacterial activity.

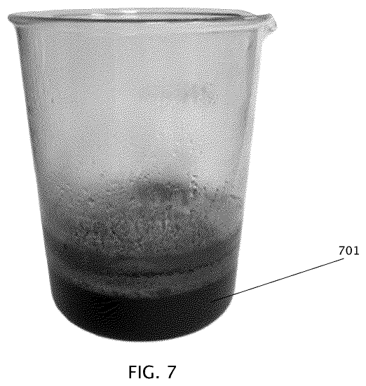

The secondary recovery of 3-DA following resin purification yields a dense, dark purple or red gel, depending on the source materials for 3-DA, and the relative ratios of the four target compounds determine the color of the gel. If the desorption from the resin uses a low percentage of ethanol (e.g., 65 weight percent ethanol), the final product before freeze-drying may be a dense liquid 701, as shown in FIG. 7.

Following the second solvent reduction and pasteurization process 112, a stable product with an elevated concentration of 3-DA compounds is obtained. This product may be used as a food additive, food colorant, nutritional supplement, or for other applications. If the product is not used immediately, the product can be freeze dried 114 to eliminate residual water and stabilize the extract for extended shelf life. To facilitate transport, storage, and combination with other materials, freeze drying 114 may be used. In one embodiment, a liquid 801 may be placed onto a silicone mat 802 in freeze-drying trays 803. The freeze dryer may be engaged for as long as necessary to remove any residual water. Final freeze-drying reduces water activity by creating a dry powder 805 that is both stable and suitable for storage. High-performance liquid chromatography (HPLC) 115 may be performed to verify the quality of the final product. The final product may be placed in storage, such as amber glass containers, upon removal from the freeze dryer. The final product may be a dense red or dense purple color, depending on the balance of luteolinidin and apigeninidin in the original grain sample. In certain embodiments, the 3-DA extract product is a cohesive gel at room temperature and a flaky solid 805 at −20° C.

Three components of a safe and stable commercial product disclosed herein are pasteurization to eliminate microbial activity, removal of fat to prevent lipid oxidation and rancidity, and reduced water activity to enhance the chemical stability of antioxidants, minimize residual lipid oxidation or enzymatic activity, and prevent reactivity of the 3-DA extract and other complex molecules. The concentration of the disclosed 3-DA extract is achieved without accumulation of bitter tannins or toxic heavy metals. Measurements of heavy metals show that the levels of cadmium, arsenic, lead, and mercury were significantly below the thresholds required for whole grains. Although no heavy metal limits have been set for 3-DA extracts, using whole-grain heavy metal standards, the 3-DA concentration can be increased by more than 1000 times without a corresponding rise in undesirable heavy metals.

Isolating the 3-DA from the whole sorghum provides the benefits of consuming large amounts of sorghum while giving consumers a more palatable and easier to consume product. Some embodiments of the methods described herein concentrate 3-DA from seeds by more than 1000 times. This allows the equivalent of 3-DA found in 50 grams of sorghum meal to be delivered in a single capsule for human consumption. For example, sorghum containing high 3-DA levels contains between 75 mg/kg and 150 mg/kg of 3-DA in the grain. This means that consuming 50 grams of high-3-DA sorghum provides a person with the equivalent of approximately 4 to 8 mg of 3-DA per day. Further, some methods disclosed herein produce a palatable 3-DA extract commercial product with a long shelf-life and sustained antioxidant activity. The 3-DA extract disclosed herein, when added to acetic acid (i.e., vinegar), remains neutral in flavor, adding color without imparting a noticeable taste.

Throughout most of the isolation and purification process, the solvent maintains low pH levels, such as less than 4.6 pH or less than 3.0 pH. Therefore, pasteurization requires relatively short exposures to boiling temperatures (100° C. for water) to achieve microbial inactivation, since the effect of heat on microorganisms is enhanced by the low pH of the solvents. Complete removal of all lipids is difficult to achieve. However, combining significant physical defatting with low final water activity to stop enzymatic activity, significantly extends the shelf life of the final 3-DA food additive or nutraceutical product.

Some experimental results were collected and analyzed for their properties. One method produced a concentrated extract appropriate for a food supplement or nutraceutical. An initial extraction performed using non-food analytical methods based on acetone extraction demonstrated acceptable metal concentrations.

TABLE 1
Comparison of grain concentration and extraction for different types of seed and
compounds, using the embodiment of 95% ethanol extraction and a SUNRESIN resin.

| | | Grain | Initial | Resin |
|---|---|---|---|---|
| | | Concentration | Extraction | Purification |
| | | (Acetone | from Bran | of Bran |
| | | extraction)* | 95% Ethanol | Extract |
| Type | Compound | milligrams/kilogram | milligrams/kilogram | milligrams/kilogram |
| Black Seed | Luteolinidin | 50 | 456 | 2083 |
| Black Seed | Apigeninidin | 18 | 175 | 727 |
| Black Seed | 7-Methoxy- | 20 | 65 | 562 |
| | Apigeninidin | | | |
| Black Seed | 5-Methoxy- | 32 | 175 | 554 |
| | Luteolinidin | | | |
| Red Seed | Luteolinidin | 2 | 8 | 133 |
| Red Seed | Apigeninidin | 63 | 551 | 1895 |
| Red Seed | 7-Methoxy- | 32 | 17 | 443 |
| | Apigeninidin | | | |
| Red Seed | 5-Methoxy- | 1 | 87 | 22 |
| | Luteolinidin | | | |
| Black Seed | Total 3- | 120 | 871 | 3926 |
| | Dexoyanthocyanidin | | | |
| Red Seed | Total 3- | 98 | 663 | 2493 |
| | Dexoyanthocyanidin | | | |

For the results of Table 1, acetone is used as an analytical solvent to determine absolute concentration in the grain. Ethanol is used as a food-grade solvent for extraction. The greater the ethanol concentration, the greater the extraction efficiency. The 70 percent ethanol extraction treatment was used to test lower-cost extraction processes.

Embodiments herein include 3-DA extraction methods, a 3-DA concentrate, and products comprising the 3-DA concentrate. As a group, the flavonoids, including the 3-DAs found in sorghum, exhibit strong antioxidant activity. Compositions comprising flavone extracts from red and black sorghum varieties can be added to a range of whole-grain food products. The resin-based purification process effectively removes the characteristic “off flavors” of sorghum, which are difficult to mask in food products and are considered undesirable by many consumers. This enables the extract to be added to non-sorghum food products, such as whole-grain food products, which combine the benefits of fiber with the antioxidant activities of 3-DA. The 3-DA concentrate from the disclosed extraction process can be used in vinegar or other acidic foods and condiments without affecting palatability, as the 3-DA extract has a neutral taste following the disclosed extraction procedure. Other embodiments of acidic foods to which 3-DA may be added include fruit juices or energy drinks containing citric acid. In one embodiment, 3-DA is purified from grain and plant material via methods such as filtration or resin beds, in combination with pasteurization, defatting, and reduced water activity. This process concentrates 3-DA to levels that enable the product to have a stable shelf life necessary for marketing as a nutraceutical and specialty functional food.

The 3-DA compounds occur at approximately 100 mg/kg of grain in sorghum varieties bred for elevated 3-DA concentration, with the highest concentrations located in the bran fraction. Achieving an effective dose that yields measurable health benefits would require consuming roughly 50 grams of whole-grain, high-3-DA sorghum per day, an amount that would effectively replace one meal for the average individual. Such a regimen is unlikely to be practical or sustainable for most consumers. Concentrating the 3-DA enables incorporation into a wide range of foods or allows for direct consumption, thereby providing the desired antioxidant activity without requiring excessive grain consumption.

A final product for a user may take many forms. Concentrated 3-DA can be used as an additive to non-sorghum whole grain products to deliver the necessary benefits to metabolic health. In another embodiment, the use of high-protein sorghum may enhance the ability to produce low-glycemic-index food products. The added protein, combined with 3-DA, stimulates prolonged insulin production for hours rather than just minutes, which is typical with sugar or starch consumption. In another embodiment, 3-DA is concentrated into a tablet or chewable form designed for absorption into the bloodstream.

TABLE 2
Concentrations of metallic elements in 3-DA
extracts following methods described herein.

| | Concentration | | FAO Codex Alimentarius |
|---|---|---|---|
| | Measured in 3-DA | | Standards for Maximum |
| Element | Extract. | | Allowable Levels.* |
| Calcium | 331 | ppm | None set |
| Potassium | 24,500 | ppm | None set |
| Sodium | 291 | ppm | None set |
| Cadmium | 30 | ppb | 100 ppb (Standard for cereals) |
| Arsenic | 63 | ppb | 200 ppb (Standard for rice, |
| | | | polished) |
| Lead | 139 | ppb | 200 ppb (Standard for cereals) |

| | | |
|---|---|---|
| Mercury | Below detectable levels. | 100 ppb (Standard for salt) |

Heavy metal elements represent a primary concern, as it is necessary to verify that the process does not preferentially concentrate these contaminants. Calcium, potassium, and sodium are included as examples of minerals that are typically a part of a healthy diet. Standard levels for the disclosed extract have not been determined. This is the most relevant standard within FAO Codex Alimentarius for international trade. The levels for the whole grain were selected to confirm that the process was not preferentially elevating the heavy metal concentrations above the limits for the starting materials.

An experiment with 2,138 C. elegans nematodes using an excessive glucose stress diet was conducted, the results are shown in Table 3.

TABLE 3
Comparison of Sorghum Extracts with Historical
Reference Compounds for Metabolic Health.

Experimental Group

| (Extract source and | | | Mean Survival | % Change | |
|---|---|---|---|---|---|
| mg/ml of 3-DA total) | Mean Survival¹ | | of Placebo* | in Survival | |
| Black Sorghum Extract | 15.23 ± 0.42 | days | 14.61 ± 0.37 days | 4.24% | (ns)² |
| 1.0 mg/mL | | | | | |
| Black Sorghum Extract | 16.02 ± 0.53 | days | 14.61 ± 0.37 days | 9.65% | (****)³ |
| 2.0 mg/mL | | | | | |
| Black Sorghum Extract | 15.90 ± 0.34 | days | 14.61 ± 0.37 days | 8.82% | (****) |
| 4.0 mg/mL | | | | | |
| Red Sorghum Extract | 16.11 ± 0.37 | days | 14.61 ± 0.37 days | 10.27% | (****) |
| 1.0 mg/mL | | | | | |
| Red Sorghum Extract | 16.62 ± 0.40 | days | 14.61 ± 0.37 days | 13.76% | (****) |
| 2.0 mg/mL | | | | | |
| Red Sorghum Extract | 17.39 ± 0.37 | days | 14.61 ± 0.37 days | 19.03% | (****) |
| 3.0 mg/mL | | | | | |
| Red Sorghum Extract 4.0 | 17.13 ± 0.40 | days | 14.61 ± 0.37 days | 17.25% | (****) |
| mg/mL + | | | | | |
| Black Sorghum Extract | | | | | |
| 4.0 mg/mL | | | | | |
| Red Sorghum Extract 2.0 | 16.53 ± 0.42 | days | 14.61 ± 0.37 days | 13.14% | (****) |
| mg/mL + | | | | | |
| Black Sorghum Extract | | | | | |
| 2.0 mg/mL | | | | | |
| Semaglutide (Ozempic)⁴ | 17 | days | | 12.5-14.3% | (****) |
| Glucose management | | | | | |
| reference. | | | | | |

¹Mean survival is determined by taking the average of all death events that occur within the observation window of 22 days. Worm-subjects that survive beyond the last observation window are not included.
²N.S.: Non-significant difference between the treatment and the placebo effect.
³***: Difference between treatment and placebo significant at the probability of p = 0.001.
⁴Semaglutide historical range of values shown.

Table 3 provides the results of feeding a nutraceutical to C. elegans nematodes. The extracts from this process were formulated into a food ration. Doses of 3-DA from black and red sorghum extract that were the equivalent of consuming 25 to 50-grams of high 3-DA sorghum extended the lifespan of the organism by 9 to 19 percent in some instances when the organism was stressed using a high-glucose diet.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in order of the processes, orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention, the scope of which is to be determined by the following claims.

We claim:

1. A method for processing red and black sorghum seed, comprising:
mechanically separating seed components into bran and endosperm-rich material;
combining the bran with ethanol;
filtering the bran and ethanol with a filter comprising resin; and
evaporating ethanol to form an extraction product.

2. The method of claim 1, further comprising combining the extraction product with other materials to form a palatable food item.

3. The method of claim 1, further comprising using a centrifuge to remove solids, a fat-containing phase, or both.

4. The method of claim 1, wherein evaporating ethanol uses a heat source.

5. The method of claim 1, wherein the filtering is repeated.

6. The method of claim 5, wherein the filter comprises resin beads.

7. A sorghum isolate composition, comprising
a 3-DA concentrate wherein
the concentration of 3-DA is at least twice as high as a whole seed, and
wherein the concentration of lead is less than 200 ppb.

8. The composition of claim 7, wherein the concentration of mercury is less than 100 ppb.

9. The composition of claim 7, wherein the concentration of cadmium is less than 100 ppb.

10. The composition of claim 7, wherein the concentration of arsenic is less than 200 ppb.

11. The composition of claim 7, wherein the concentration of 3-DA is at least 100 times as high as a concentration of 3-DA in whole seed.

12. The composition of claim 7, wherein the concentration of 3-DA is at least 1000 times as high as a concentration of 3-DA in whole seed.

13. The composition of claim 7, wherein the concentration of 3-DA is at least 2000 milligrams/kilogram.

14. The composition of claim 7, wherein the concentration of 3-DA is at least 4000 milligrams/kilogram.

15. The composition of claim 7, wherein the concentrate is a dry powder.

16. A method for creating concentrated 3-DA extracts from sorghum seed, comprising:
suspending bran in an acidified polar solvent;
separating the bran from the solvent;
evaporating the polar solvent;
removing fat;
purifying the 3-DA extract via a resin purification column;
eluting the 3-DA extract from the resin via a column rinse with a second polar solvent; and
evaporating the second polar solvent used for the column rinse.

17. The method of claim 16 further comprising utilizing ultraviolet-visible spectroscopy to verify the 3-DA compounds have been extracted, the solvent has been removed, and the fat has been removed.

18. The method of claim 16 further comprising freeze drying the 3-DA extract.

19. The method of claim 16, wherein said bran is separated from said solvent via a multi-step process, comprising:
separating large particles via a filtration process; and
removing fine particles through centrifugation.

20. The method of claim 16, wherein said acidified polar solvent is hydrochloric acid in ethanol, and wherein said column rinse is performed with an ethanol rinse.
